(19) United States
(12) Patent Application Publication
(10) Pub. No.: US 2026/0026465 A1
(43) Pub. Date: Jan. 29, 2026

(54) Extendable Feeding Device

(71) Applicant: Pamela Poeldnurk, Nesquehoning, PA (US)

(72) Inventor: Pamela Poeldnurk, Nesquehoning, PA (US)

(21) Appl. No.: 19/228,030

(22) Filed: Jun. 4, 2025

Related U.S. Application Data
(60) Provisional application No. 63/674,311, filed on Jul. 23, 2024.

(51) Int. Cl. A01K 1/035

(52) U.S. Cl. CPC A01K 1/0356

(57) ABSTRACT

An extendable feeding device is provided. The device is comprised of an extendable feeding device designed to safely and efficiently provide food and water to animals confined in cages, live traps, or crates, minimizing the risk of bites, scratches, and stress during feeding. The device comprises a stainless-steel feeding box with a sliding lid that securely holds food or water, allowing caregivers to insert the device through wire mesh without opening the enclosure. A removable handle with and non-slip grip provides adjustable reach and secure handling, while a gasket ensures spill prevention. The device enhances hygiene, prevents accidental animal escapes, and simplifies feeding for veterinary offices, animal shelters, TNR programs, and transporters, ensuring humane care and reducing contamination risks associated with traditional feeding methods.

### CROSS-REFERENCE TO RELATED APPLICATION

The present application claims priority to, and the benefit of, U.S. Provisional Application No. 63/674,311, which was filed on Jul. 23, 2024, and is incorporated herein by reference in its entirety.

### FIELD OF THE INVENTION

The present invention relates generally to the field of animal feeding devices. More specifically, the present invention relates to an extendable feeding tool designed for safely providing food and water to caged or confined animals, featuring a stainless-steel feeding box with a sliding lid that allows secure insertion through wire mesh without opening the enclosure. Accordingly, the present disclosure makes specific reference thereto. Nonetheless, it is to be appreciated that aspects of the present invention are also equally applicable to other like applications, devices, and methods of manufacture.

### BACKGROUND

Caring for feral or aggressive animals presents significant challenges, particularly when providing food and water in a safe and controlled manner. Traditional feeding methods often expose caregivers to the risk of bites or scratches, leading to potential injuries and the transmission of zoonotic diseases. Additionally, opening a cage or live trap to place food inside increases the likelihood of accidental animal escape, complicating containment efforts. Attempts to throw food or pour water into an enclosure frequently result in spillage, contaminating the cage and creating unnecessary waste. Furthermore, animals confined in cages or traps for extended periods without access to adequate nutrition or hydration may experience heightened stress and deteriorating health conditions. The issue is particularly relevant in veterinary clinics, animal shelters, and trap-neuter-return (TNR) programs, where efficient and humane feeding solutions are essential. Without a reliable feeding system, caregivers face logistical difficulties in maintaining cleanliness and ensuring animals receive proper sustenance. Thus, there is a critical need for a device that allows safe, controlled feeding and hydration of caged or trapped animals while minimizing risks to both the caregiver and the animal.

Therefore, there exists a long-felt need in the art for an extendable feeding device that reduces the risk of caregivers being bitten or scratched when feeding feral or aggressive animals. There also exists a long-felt need in the art for an extendable feeding device that ensures animals in cages or traps receive adequate food and water without excessive spillage or contamination. Moreover, there exists a long-felt need in the art for an extendable feeding device that prevents accidental animal escape while allowing caregivers to feed and hydrate animals with minimal direct interaction.

The subject matter disclosed and claimed herein, in one embodiment thereof, comprises an extendable feeding device. The device is comprised of an extendable feeding device designed to safely and efficiently provide food and water to animals confined in cages, live traps, or crates, minimizing the risk of bites, scratches, and stress during feeding. The device comprises a stainless-steel feeding box with a sliding lid that securely holds food or water, allowing caregivers to insert the device through wire mesh without opening the enclosure. A removable handle and non-slip grip provides adjustable reach and secure handling, while a gasket ensures spill prevention. The device enhances hygiene, prevents accidental animal escapes, and simplifies feeding for veterinary offices, animal shelters, TNR programs, and transporters, ensuring humane care and reducing contamination risks associated with traditional feeding methods.

In this manner, the extendable feeding device of the present invention accomplishes all the foregoing objectives and provides a device designed to safely and efficiently deliver food and water to animals in cages, live traps, or crates. More specifically, the feeding box is designed to fit through standard wire mesh openings, eliminating the need to open the enclosure and thereby reducing the risk of escape. Further, the handle enables caregivers to insert and retrieve the device without placing their hands inside the cage, minimizing the risk of injury. By facilitating a safer and more hygienic feeding process, the extendable feeding device significantly improves the handling of feral, aggressive, or frightened animals in veterinary settings, animal shelters, and rescue operations.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an extendable feeding device. The extendable feeding device is a specialized tool for safely providing food and water to animals in cages, live traps, or crates from outside of the enclosure to reduce the risk of bites, scratches, and stress. It is particularly beneficial in veterinary offices, animal shelters, rescue organizations, trap-neuter-return (TNR) programs, and animal transport. The device is comprised of a stainless-steel feeding box sized to fit through standard wire mesh enclosures, allowing food or water to be provided without opening the cage. A sliding lid secures the contents, and a secondary handle enables controlled opening and closing once the feeding box is inside the enclosure. In one embodiment, an internal divider separates food and water, while a gasket prevents spills.

A primary handle is attached to the feeding box, available in fixed or telescopic variations, with a locking mechanism to maintain the desired length. A catch near the handle prevents the device from being fully pulled into the cage, enhancing safety. The handle features a non-slip grip area, optionally textured and ergonomically contoured to reduce strain during use.

The device minimizes direct contact with aggressive or frightened animals by allowing food and water to be placed into an enclosure from outside the enclosure, enhancing safety and hygiene compared to traditional feeding methods. The device is particularly effective for handling feral or stressed animals while preventing contamination from bowls left inside enclosures.

A method of using the device involves filling the feeding box with food or water, securing the lid, extending the handle if necessary, and inserting the device through a wire mesh cage. Once inside, the lid is opened to allow the animal access. After feeding, the lid is closed to contain any remaining contents before the device is safely removed.

Accordingly, the extendable feeding device of the present invention is particularly advantageous as it provides a device designed to safely and efficiently deliver food and water to animals in cages, live traps, or crates. More specifically, the feeding box is designed to fit through standard wire mesh openings, eliminating the need to open the enclosure and thereby reducing the risk of escape. Further, the handle enables caregivers to insert and retrieve the device without placing their hands inside the cage, minimizing the risk of injury. By facilitating a safer and more hygienic feeding process, the extendable feeding device significantly improves the handling of feral, aggressive, or frightened animals in veterinary settings, animal shelters, and rescue operations.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an extendable feeding device of the present invention in accordance with the disclosed architecture;

FIG. 2 illustrates a perspective view of one potential embodiment of an extendable feeding device of the present invention while being inserted into a cage in accordance with the disclosed architecture;

FIG. 3 illustrates a flowchart of a method of using one potential embodiment of an extendable feeding device of the present invention in accordance with the disclosed architecture; and

FIG. 4 illustrates a top view of one potential embodiment of an extendable feeding device of the present invention with the primary handle detached from the feeding box in accordance with the disclosed architecture

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an extendable feeding device that reduces the risk of caregivers being bitten or scratched when feeding feral or aggressive animals. There also exists a long-felt need in the art for an extendable feeding device that ensures animals in cages or traps receive adequate food and water without excessive spillage or contamination. Moreover, there exists a long-felt need in the art for an extendable feeding device that prevents accidental animal escape while allowing caregivers to feed and hydrate animals with minimal direct interaction.

The present invention, in one exemplary embodiment, is comprised of an extendable feeding device. The extendable feeding device is a specialized tool designed to safely provide food and water to animals in cages, live traps, or crates from outside the enclosure, reducing the risk of bites, scratches, and stress. It is particularly useful in veterinary offices, animal shelters, rescue organizations, trap-neuter-return (TNR) programs, and animal transport.

The device is comprised of a stainless-steel feeding box sized to pass through standard wire mesh openings, allowing food or water to be provided without opening the cage. A sliding lid secures the contents, and a secondary handle allows controlled opening and closing once the feeding box is inside the enclosure. In one embodiment, an internal divider separates food and water, while a gasket prevents spills.

A primary handle is attached to the feeding box, available in fixed, removable, or telescopic variations. A catch near the handle prevents the device from being pulled fully into the cage, enhancing safety. The handle includes a non-slip grip area, which may be textured and ergonomically contoured to reduce strain during use.

By allowing food and water to be placed into an enclosure from outside, the device minimizes direct contact with aggressive or frightened animals, enhancing safety and hygiene compared to traditional feeding methods. It is particularly effective for handling feral or stressed animals while preventing contamination from bowls left inside enclosures.

The method of use involves filling the feeding box with food or water, securing the lid, extending the handle if needed, and inserting the device through a wire mesh cage. Once inside, the lid is opened to allow the animal access. After feeding, the lid is closed to contain any remaining contents before the device is safely removed.

The extendable feeding device offers a safe and efficient way to deliver food and water to animals in cages, live traps, or crates. The feeding box is designed to fit through standard wire mesh openings, eliminating the need to open the enclosure and reducing the risk of escape. Additionally, the handle enables caregivers to insert and retrieve the device without placing their hands inside the cage, minimizing the risk of injury. By improving the safety and hygiene of the feeding process, the device significantly enhances the handling of feral, aggressive, or frightened animals in veterinary settings, animal shelters, and rescue operations.

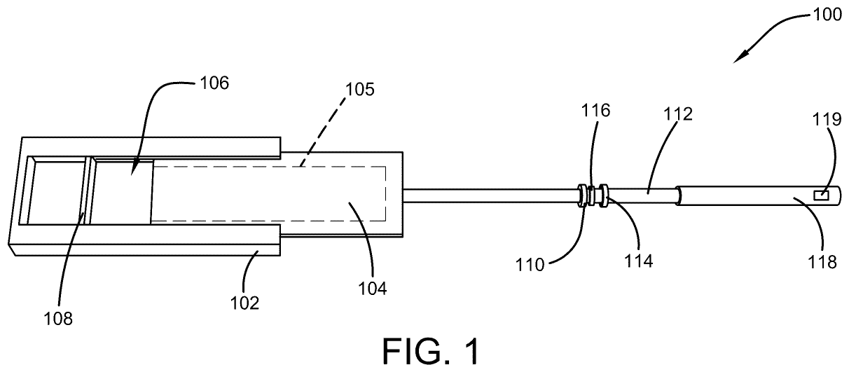

Referring initially to the drawings, FIG. 1 illustrates a perspective view of one potential embodiment of an extendable feeding device 100 of the present invention in accordance with the disclosed architecture. The extendable feeding device 100 is a specialized tool designed to safely and efficiently provide food or water to animals confined in cages, live traps, or crates. The device 100 is particularly beneficial in veterinary offices, animal shelters, rescue organizations, trap-neuter-return (TNR) programs, and long-distance animal transport. The primary focus of the device 100 is to enhance safety, hygiene, and ease of use, ensuring that caregivers can feed and/or hydrate animals without placing their hands inside the enclosure. This minimizes the risk of bites, scratches, or unnecessary stress to the animal.

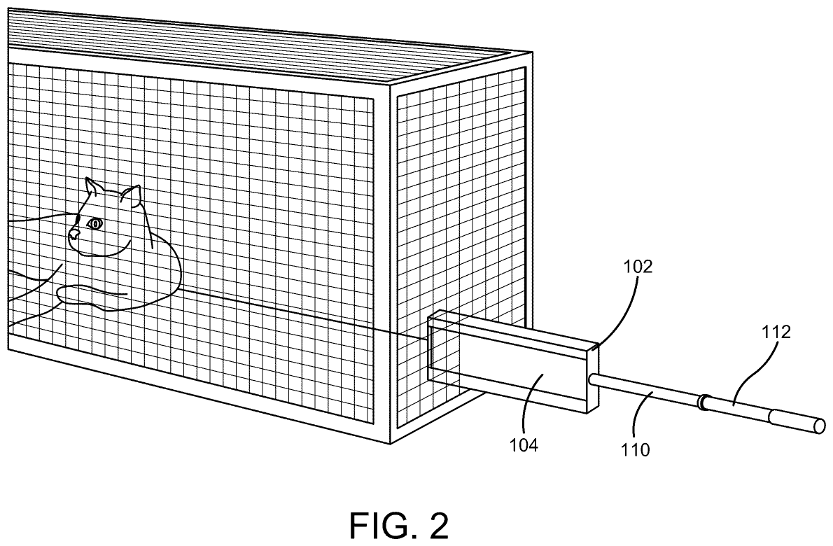

The device 100 is comprised of a stainless-steel feeding box 102. The feeding box 102 is specifically sized to fit through the gaps of the wire mesh of most standard cages or crates, allowing caregivers to insert the device 100 into the cage or crate without having to open the enclosure, as seen in FIG. 2. The feeding box 102 features a sliding lid 104 that securely holds food or water within an interior space 106. In one embodiment, the interior space 106 is comprised of at least one divider 108, as seen in FIG. 1, which divides the interior space 106 into separate food and water areas. A secondary handle 110 at the back of the lid 104 allows the user to slide the lid 104 open once the feeding box 102 is inside the enclosure, giving the animal access to the interior space 106. After the animal has finished eating or drinking, the user can slide the lid 104 shut via the handle 110 before removing the device 100, keeping any remaining contents contained and reducing mess. In one embodiment, the lid 104 is comprised of a gasket 105 to ensure the contents of the interior space 106 do not spill during movement. The gasket 105 may be made of food-grade silicone or other flexible, non-porous materials designed to create a secure seal.

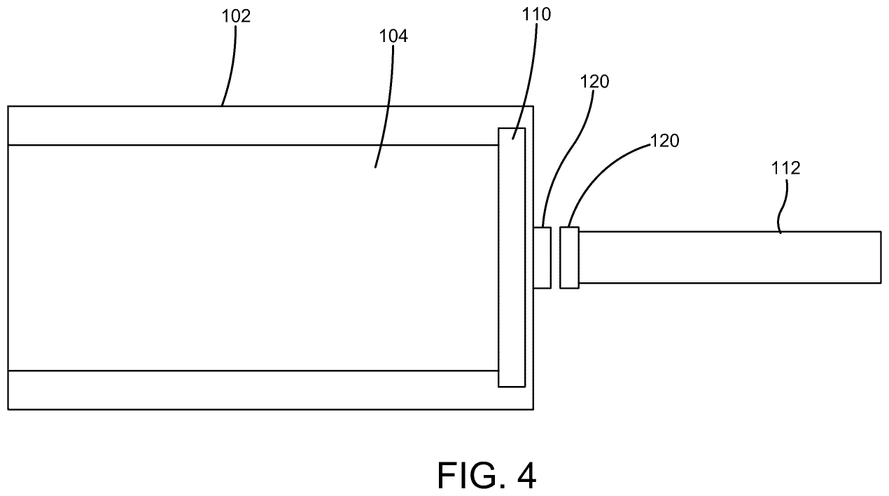

At least one primary handle 112 is attached to the feeding box 102. In one embodiment, the handle 112 removably attaches to the box 102 via a set of reciprocating fasteners 120 such as but not limited to threads, tongue and groove, male and female, etc. This allows the box 102 to be used as a standalone feeding dish if desired, as seen in FIG. 4. In one embodiment, the handle 112 is of a fixed length. In a different embodiment, the handle 112 is telescopic and therefore adjustable in length. The length of the handle 112 in this embodiment can be locked with a locking mechanism 114 such as, but not limited to, a twist-lock mechanism, a push-button locking system, or a spring-loaded pin lock. These mechanisms ensure that the handle 112 remains securely extended during use while allowing for easy retraction when necessary. The handle 112 is designed with a catch 116 near the handle, preventing the handle 112 from being fully pulled into the cage by the animal.

For added convenience and comfort, the handle 112 may be comprised of a non-slip grip area 118, providing a secure, non-slip hold and reducing strain on the user's hand. The grip area 118 is further preferably textured with textures such as, but not limited to, raised ridges, dimples, or rubberized patterns to enhance grip. In one embodiment, the grip area 118 is comprised of an ergonomic contour designed to fit comfortably in the user's hand, further minimizing strain during prolonged use. Additionally, the grip area 118 may be coated with an antimicrobial coating 119 to reduce bacterial buildup, enhancing hygiene and long-term durability.

The extendable feeding device 100 provides a practical and efficient method for feeding and hydrating animals while minimizing stress and risk to both the caregiver and the animal. The device 100 is particularly useful when handling feral, aggressive, or frightened animals, as it eliminates the need for direct human contact during feeding. By reducing the likelihood of injuries caused by bites or scratches, the device 100 enhances safety for animal care professionals. Additionally, the device 100 has a significant advantage over traditional feeding bowls, which may remain inside the enclosure and become contaminated over time.

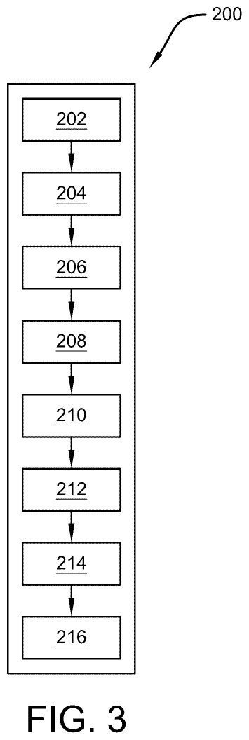

The present invention is also comprised of a method of using 200 the extendable feeding device 100, as seen in FIG. 3. First, a device 100 is provided, comprising a feeding box 102, a sliding lid 104, an interior space 106, at least one handle 112, and a grip area 118 [Step 202]. Then, the feeding box 102 is filled with food and/or water within the interior space 106. If the interior space 106 includes at least one divider 108, the food and water are placed into separate sections accordingly [Step 204]. Next, the sliding lid 104 is moved into a closed position to securely contain the food and/or water. If the lid 104 is comprised of a gasket 105, the gasket 105 provides a seal to prevent spills during movement [Step 206]. The user then grips the handle 112 and extends it, if the handle 112 is telescopic, adjusting the length as needed and locking it in place using the locking mechanism 114 [Step 208]. Then, the feeding box 102 is inserted through the gaps of a wire mesh cage or crate until it is fully positioned inside the enclosure [Step 210]. Once inside, the sliding lid 104 is moved into an open position using the secondary handle 110, allowing the animal access to the contents of the interior space 106 [Step 212]. After the animal has finished cating or drinking, the sliding lid 104 is moved back into a closed position using the secondary handle 110 to contain any remaining food or liquid [Step 214]. Finally, the feeding box 102 is removed from the enclosure by pulling the handle 112 while ensuring that the catch 116 prevents the device 100 from being pulled into the cage by the animal [Step 216].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “extendable feeding device” and “device” are interchangeable and refer to the extendable feeding device 100 of the present invention.

Notwithstanding the foregoing, the extendable feeding device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the extendable feeding device 100 as shown in the FIGS. are for illustrative purposes only, and that many other sizes and shapes of the extendable feeding device 100 are well within the scope of the present disclosure. Although the dimensions of the extendable feeding device 100 are important design parameters for user convenience, the extendable feeding device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An extendable feeding device comprising:
a feeding box comprised of an interior space;
a sliding lid coupled to the feeding box, the sliding lid movable between a closed position and an open position to selectively enclose the interior space;
a secondary handle attached to the sliding lid, the secondary handle configured to facilitate movement of the sliding lid between the closed position and the open position; and
a primary handle attached to the feeding box.

2. The extendable feeding device of claim 1, wherein the interior space is comprised of a divider.

3. The extendable feeding device of claim 1 further comprised of a gasket.

4. The extendable feeding device of claim 1, wherein the primary handle is comprised of a non-slip grip.

5. The extendable feeding device of claim 4, wherein the non-slip grip is comprised of a texture.

6. The extendable feeding device of claim 4, wherein the non-slip grip is comprised of an antimicrobial coating.

7. The extendable feeding device of claim 3, wherein the gasket is comprised of a flexible material.

8. The extendable feeding device of claim 4, wherein the non-slip grip is comprised of a contoured grip.

9. An extendable feeding device comprising:
a feeding box comprised of an interior space;
a sliding lid coupled to the feeding box, the sliding lid movable between a closed position and an open position to selectively enclose the interior space;
a secondary handle attached to the sliding lid, the secondary handle configured to facilitate movement of the sliding lid between the closed position and the open position; and
a removable primary handle attached to the feeding box.

10. The extendable feeding device of claim 9, wherein the removable primary handle is telescopic.

11. The extendable feeding device of claim 9 further comprised of a locking mechanism comprised of a push-button lock or a twist lock.

12. The extendable feeding device of claim 9, wherein the locking mechanism is comprised of a spring-loaded pin lock.

13. The extendable feeding device of claim 9, wherein the interior space is comprised of a divider.

14. The extendable feeding device of claim 9 further comprised of a gasket.

15. The extendable feeding device of claim 9, wherein the primary handle is comprised of a non-slip grip.

16. The extendable feeding device of claim 15, wherein the non-slip grip is comprised of a texture.

17. The extendable feeding device of claim 15, wherein the non-slip grip is comprised of an antimicrobial coating.

18. The extendable feeding device of claim 14, wherein the gasket is comprised of a flexible material.

19. The extendable feeding device of claim 15, wherein the non-slip grip is comprised of a contoured grip.

20. A method of using an extendable feeding device, the method comprising the following steps:
providing an extendable feeding device comprised of a feeding box, a sliding lid, an interior space, and a primary handle;
placing a food or a water within the interior space of the feeding box;
moving the sliding lid into a closed position to enclose the food or the water in the feeding box;
gripping the primary handle and inserting the feeding box into a cage or an enclosure until the feeding box is inside the cage or the enclosure;
moving the sliding lid into an open position to allow an animal access to the food or the water;
moving the sliding lid back into the closed position after the animal has finished eating or drinking; and
removing the feeding box from the cage or the enclosure by pulling the primary handle.
